(19) United States
(12) Patent Application Publication
(10) Pub. No.: US 2012/0246715 A1
(43) Pub. Date: Sep. 27, 2012

(54) RECORDING DEVICE AND CONTROL METHOD THEREFORE

(75) Inventor: Seiji Toda, Tachikawa-shi (JP)

(73) Assignee: KABUSHIKI KAISHA TOSHIBA, Tokyo (JP)

(21) Appl. No.: 13/334,687

(22) Filed: Dec. 22, 2011

(30) Foreign Application Priority Data
Mar. 24, 2011 (JP) 2011-065286

(51) Int. Cl. G06F 12/14

(52) U.S. Cl. 726/16

(57) ABSTRACT

One embodiment provides a recording device, including: a data storage module; an authentication information storage module configured to store authentication information; a receiving module configured to receive authentication information from a higher level apparatus; an authenticating module configured to perform authentication of access to the data storage module by comparing the received authentication information with the stored authentication information; a command tendency storage module configured to store a command tendency; a command tendency determinator configured to determine whether or not a command tendency relating to commands being transmitted from the higher level apparatus is similar to the previously-stored command tendency; and a use disabling module configured to render the data stored in the data storage module substantially unusable based on a determination of the command tendency determinator.

### CROSS-REFERENCE TO RELATED APPLICATION(S)

This application claims priority from Japanese Patent Application No. 2011-065286 filed on Mar. 24, 2011, the entire contents of which are incorporated herein by reference.

### FIELD

Embodiments described herein relate generally to a recording device and its control method.

### BACKGROUND

Various improvements have been made in recording devices having an abnormality detecting function. For example, in JP-2008-117007-A, abnormality detection is performed by collecting access/command logs in server maintenance work and comparing their tendency with a tendency of previous ones. In this approach, attention is paid to an access frequency in a predetermined time and a user is notified or a communication channel is disconnected when an abnormality is detected.

For example, it is further desired to lock a security function by paying attention to a command sequence or command issuance intervals in particular processing with which increase in accuracy is expected.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates a system configuration of an electronic apparatus equipped with a magnetic disk device according to a first embodiment.

FIG. 2 illustrates a firmware configuration according to the first embodiment.

FIG. 3 illustrates a functional configuration of an important part of a recording device according to the first embodiment.

FIG. 4 illustrates an activation process which uses the firmware of FIG. 2.

FIG. 5 illustrates another activation process which uses the firmware of FIG. 2.

FIG. 6 illustrates security settings used in the first embodiment.

FIG. 7 illustrates a system configuration of an electronic apparatus according to a second embodiment.

### DETAILED DESCRIPTION

In general, one embodiment provides a recording device, including: a data storage module configured to store data; an authentication information storage module configured to store authentication information to be used for an authentication of access to the data storage module; a receiving module configured to receive authentication information that is transmitted from a higher level apparatus; an authenticating module configured to perform the authentication of access to the data storage module by comparing the authentication information received by the receiving module with the authentication information stored in the authentication information storage module; a command tendency storage module configured to store a command tendency, the command tendency including an order or a timing of commands that have been transmitted from the higher level apparatus; a command tendency determinator configured to determine whether or not a command tendency relating to commands being transmitted from the higher level apparatus is similar to the command tendency previously having been stored in the command tendency storage module; and a use disabling module configured to render the data stored in the data storage module substantially unusable based on a determination of the command tendency determinator.

Embodiments will be described below.

### Embodiment 1

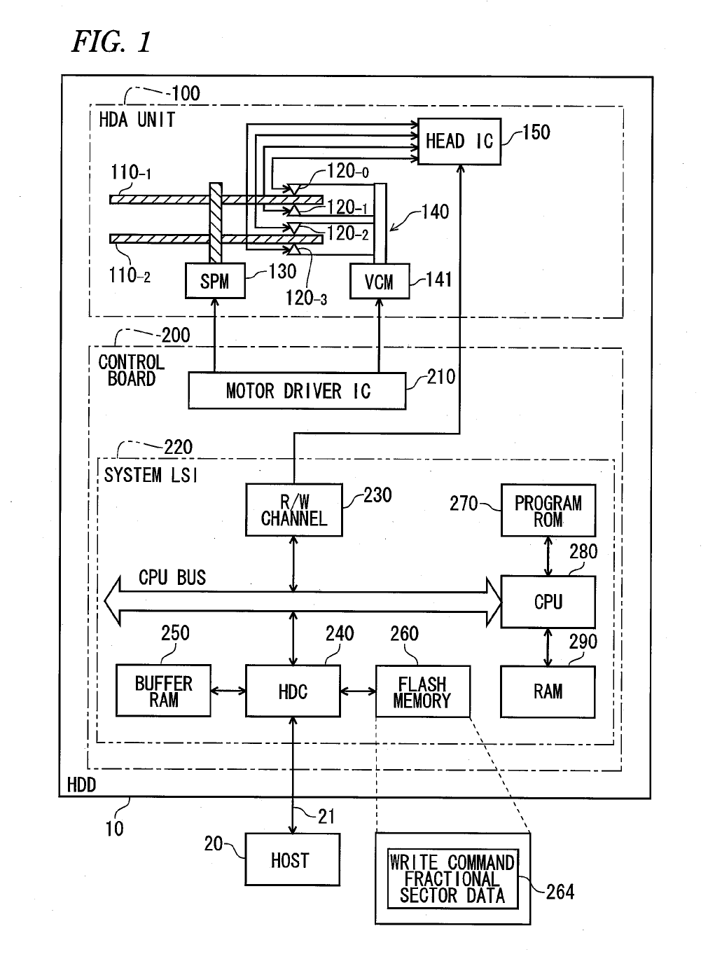

A first embodiment will be hereinafter described with reference to FIGS. 1-6.

FIG. 1 illustrates a system configuration of an electronic apparatus which is equipped with a magnetic disk device according to the first embodiment. As shown in FIG. 1, the electronic apparatus is equipped with a magnetic disk device (HDD) 10 and a host (host system) 20. For example, the electronic apparatus is a personal computer, a video camera, a music player, a portable terminal, or a cell phone. The host 20 uses the HDD 10 as its storage device.

The HDD 10 is equipped with a head-disk assembly (HDA) unit 100 and a control board 200. The HDA unit 100 is equipped with two disks (magnetic disks) 110-1 and 110-2, for example, a spindle motor (SPM) 130, an actuator 140, and a head IC 150.

Each of the disks 110-1 and 110-2 has two (top and bottom) recording surfaces. The disks 110-1 and 110-2 are rotated at high speed by the SPM 130. The disk 110-i (i=1, 2) employs a known recording format called CDR (constant density recording). Therefore, each recording surface of the disk 110-i is managed being divided into plural zones in its radial direction. That is, each recording surface of the disk 110-i has plural zones.

In the actuator 140, heads (magnetic heads) 120-0 and 120-1 are provided at the tips of head arms which are provided for the respective recording surfaces of the disk 110-1 and heads 120-2 and 120-3 are provided at the tips of head arms which are provided for the respective recording surfaces of the disk 110-2. The heads 120-0 and 120-1 are used for writing and reading data on and from the disk 110-1, and the heads 120-2 and 120-3 are used for writing and reading data on and from the disk 110-2.

The actuator 140 is equipped with a voice coil motor (VCM) 141. Driven by the VCM 141, the actuator 140 moves the heads 120-0 to 120-3 in the radial directions of the disks 110-1 and 110-2.

The SPM 130 and the VCM 141 are driven by respective currents (SPM current and VCM current) which are supplied from a motor driver IC 210 (described later).

The head IC 150 amplifies a signal (read signal) that is read out by the head 120-j (j=0, 1, 2, 3). Furthermore, the head IC 150 converts write data that is transferred from a read/write channel 230 (described later) into a write current and outputs it to the head 120-j.

The control board 200 is equipped with two LSIs, that is, the motor driver IC 210 and a system LSI 220. The motor driver IC 210 drives the SPM 130 so that it is rotated at a constant rotation speed. Furthermore, the motor driver IC 210 drives the actuator 140 by supplying the VCM 141 with a current (VCM current) having a value corresponding to a VCM manipulation amount specified by a CPU 280.

The system LSI 220 is an SOC (system on chip) LSI in which the read/write channel (R/W channel) 230, a disk controller (HDC) 240, a buffer RAM 250, a flash memory 260, a program ROM 270, the CPU 280, and a RAM 290 are integrated into a single chip.

The R/W channel 230 is a signal processing device which performs signal processing that relates to reading and writing. The R/W channel 230 converts a read signal into digital data and decodes the digital data into read data. Furthermore, the R/W channel 230 extracts, from the digital data, servo data that is necessary for positioning of the head 120-j. Still further, the R/W channel 230 encodes write data.

The HDC 240 is connected to the host 20 via a host interface 21. The HDC 240 receives a command (write command, read command, or the like) that is transferred from the host 20. The HDC 240 controls data transfer between the host 20 and itself. The HDC 240 also controls data transfer between the disk 110-i (i=1, 2) and itself which is performed via the R/W channel 230.

The buffer RAM 250 is used for temporarily storing data to be written to the disk 110-i or data that has been read from the disk 110-i via the head IC 150 and the R/W channel 230.

The flash memory 260 is a rewritable nonvolatile memory. For example, the flash memory 260 is used for temporarily storing fractional sector data of a write command that is received from the host 20.

The program ROM 270 is stored with control programs (firmware programs) in advance. The control programs may be stored in a partial area of the flash memory 260.

The CPU 280 functions as a main controller of the HDD 10. The CPU 280 controls at least part of the other components of the HDD 10 according to the control programs stored in the program ROM 270. A partial area of the RAM 290 is used as a work area of the CPU 280. Part of the data stored in the flash memory 260 is loaded into the work area when the HDD 10 is powered on.

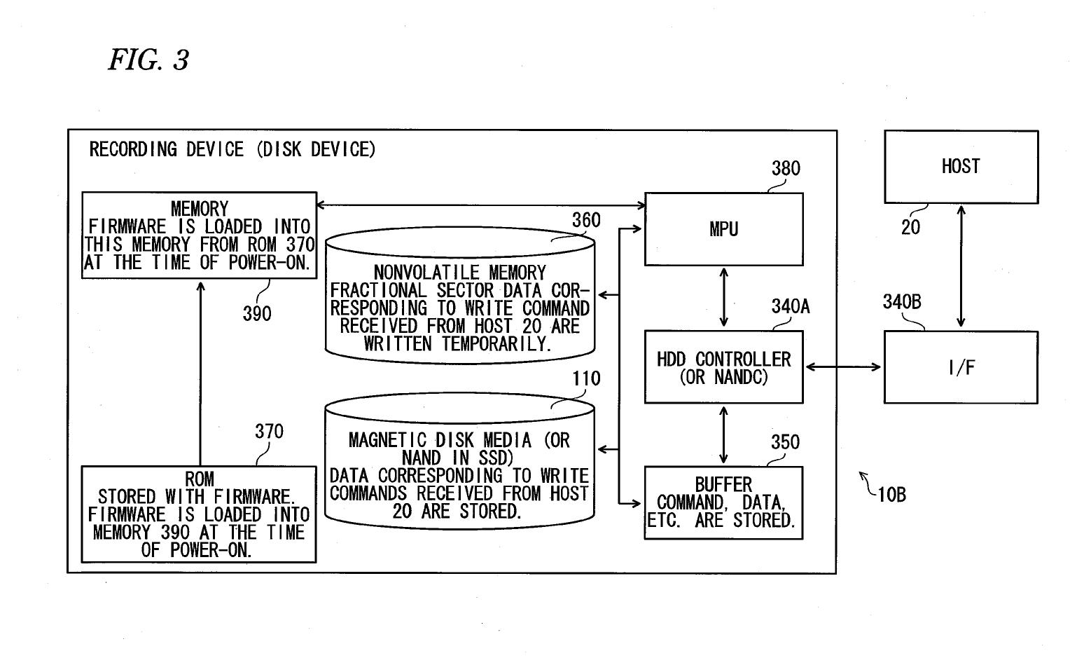

FIG. 3 illustrates a functional configuration of an important part of a recording device according to the embodiment, which is based on the hardware configuration of FIG. 1. A similar functional configuration results from a hardware configuration of an SSD (solid-state drive) or the like.

As shown in FIG. 3, a recording device (disk device) 10B is composed of an MPU 380, an HDD controller 340A, an interface (I/F) 340B, a buffer 350, a nonvolatile memory 360, magnetic disk media 110, a memory 390, and a ROM 370. Comparing the configuration of FIG. 3 with that of FIG. 1, the MPU 380 corresponds to the CPU 280, the HDD controller 340A and the I/F 340B correspond to the HDC 240, the buffer 350 corresponds to the buffer RAM 250, and the nonvolatile memory 360 corresponds to the flash memory 260. The magnetic disk media 110 correspond to the disks 110-1 and 110-2, the memory 390 corresponds to the RAM 290, and the ROM 370 corresponds to the program ROM 270.

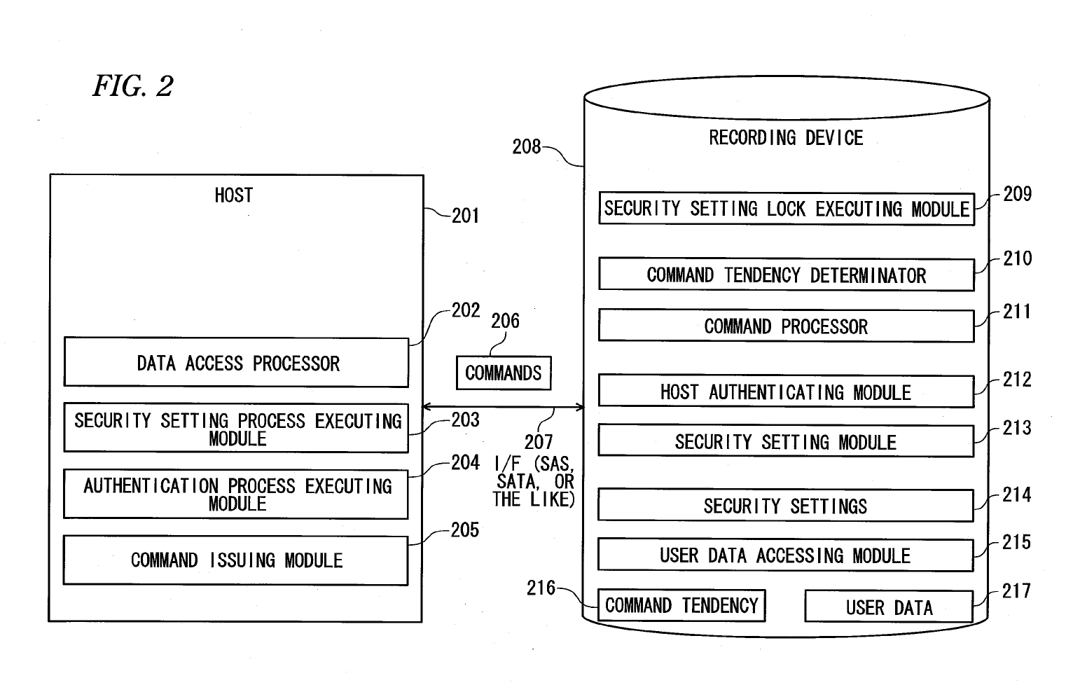

FIG. 2 illustrates a firmware configuration according to the embodiment. Individual components of a recording device 208 (a functional configuration mainly based on firmware that is executed by the CPU 380) to be described below are implemented mainly based on this firmware. This firmware is supplied from the magnetic disk media 110, the nonvolatile memory 360, or the ROM 370 to the memory 390, developed there, and executed by the MPU 380. “Security setting information,” “command tendency information,” and “user data” (all of which will be described later in detail) are stored in the magnetic disk media 110.

These information will be described briefly below. First, user data are data to be used by the user and to become a subject of access (write or read access) from a host 201. The security setting information relates to subject areas that are set for the user data by a security setting module 213 and access authority and security locks for the subject areas. The command tendency information relates to order, intervals, and a frequency of commands relating to accesses to the user data.

As shown in FIG. 2, since this example configuration assumes a system having a security function, the host 210 is equipped with a security setting process executing module 203 and an authentication process executing module 204 and the recording device 208 is equipped with a host authenticating module 212, the security setting module 213, and security settings 214.

As functions that are provided irrespective of presence/absence of a security function, the host 210 is equipped with a data access processor 202 and a command issuing module 205 and the recording device 208 is equipped with a command processor 211, a user data accessing module 215, and user data 217.

In addition to the above functions, the recording device 208 is equipped with a security setting lock executing module 209, a command tendency determinator 210, and a command tendency 216. The command tendency 216 cannot be accessed from outside the recording device 208.

Like the security settings 214, the command tendency 216 is stored in a nonvolatile storage medium (e.g., nonvolatile memory 360) of the recording device 208.

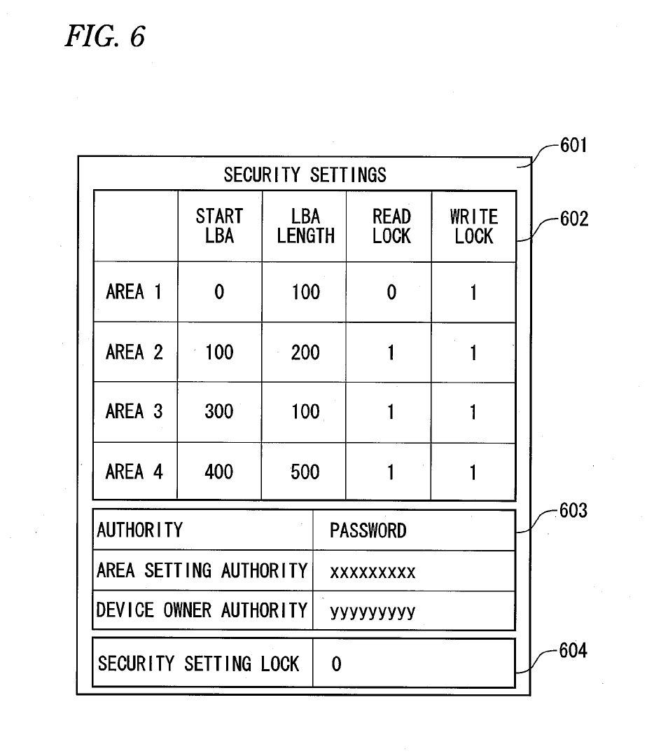

The host 201 can access the security settings 214 only via the security setting module 213 and can access the user data 217 only via the user data accessing module 215. However, the host 201 cannot directly access the security settings 214; for example, the host 201 is allowed to write or read data to or from areas for which writing or reading is permitted by the security setting module 213 according to authority settings about writing or reading by the host 201 (see an example of FIG. 6).

The security settings 214 are stored in a nonvolatile storage medium of the recording device 208. Although the embodiment assumes that the recording device 208 is an HDD or an SSD, the invention is not limited to such a case and can broadly be applied to recording devices that are connected according to standard interfaces.

The host 201 and the recording device 208 perform a communication by exchanging commands 206 via an interface 207. The data access processor 202 issues a command for accessing (read or write access) the user data 217 by giving an instruction to the command issuing module 205. In the recording device 208, access to the user data 217 is realized by the command processor 211 and the user data accessing module 215.

In the recording device 208 having the security function, the security settings 214 are used mainly for protecting the user data 217. For example, the user data 217 can be protected by making a security setting 214 to the effect that a read or write command for the user data 217 should be locked.

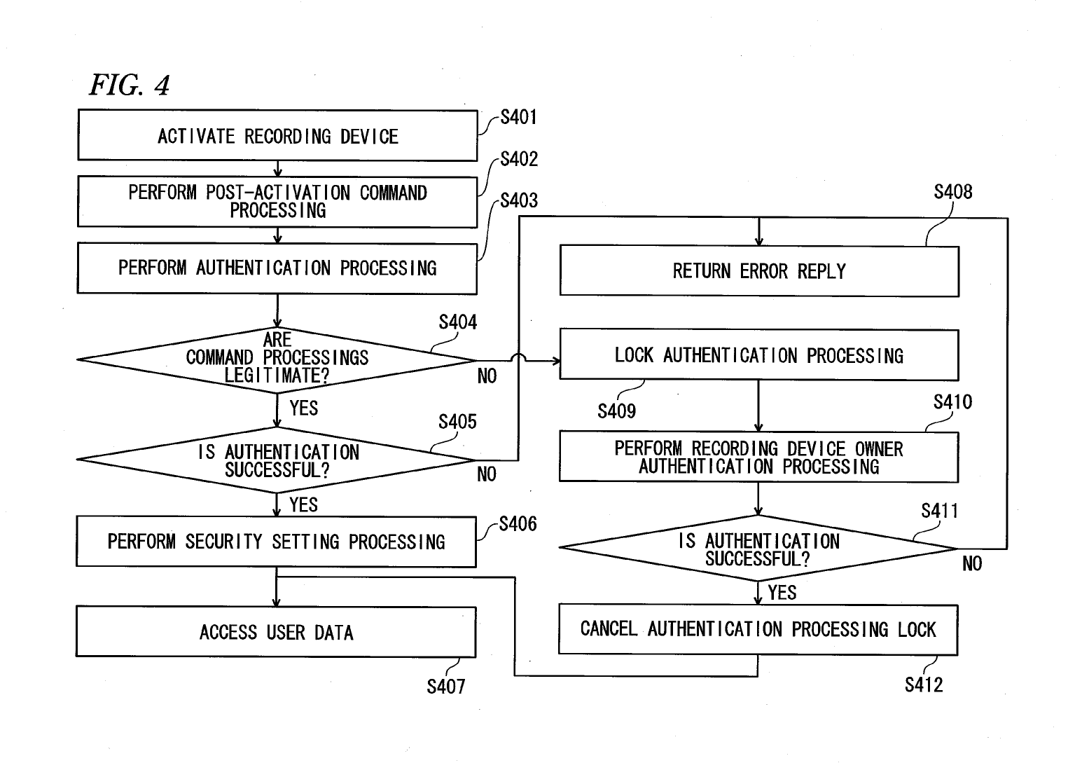

FIG. 4 illustrates a process which uses the above-described firmware and is started by the host 201 (general host) to activate the recording device 208 having the security settings 214.

At step S401, the recording device 208 is activated. Step S402 is a general command processing step which is executed after activation. This command processing step is executed irrespective of presence/absence of a security function. In general hosts, this step is a regular step.

In the recording device 208, records of the command processings are held temporarily in the buffer 350. The term “command processings” as used herein means command processings that are performed on commands excluding commands for a security purpose. At step S403, the authentication process executing module 204 causes the command issuing module 205 to issue an authentication command.

In the recording device 208 which has received this command, the command tendency determinator 210 determines at step S404 whether or not the command processings of this time are legitimate depending on whether or not similarity between a command tendency of the command processings of this time and the command tendency 216 is sufficiently high. Examples of the command tendency are a command sequence and command issuance timing. Command tendencies are compared with each other by a general data mining method (shortest distance method, single-link method, or the like). More specifically, for example, an approach to comparative determination of character string similarity (described later) may be used.

If the command processings are determined legitimate because of high similarity (S404: yes), at step S405 the host authenticating module 212 checks whether or not authentication has succeeded. If the authentication has failed (S405: no), at step S408 the recording device 208 returns an error reply. Although password authentication is performed in general, the authentication method is not limited to it. If the authentication has succeeded (S405: yes), at step S406 the recording device 208 performs security setting processing. As described later, a read or write command may be locked. In such a case, the security setting process executing module 203 unlocks it in advance. At step S407, the data access processor 202 accesses user data 217.

If the command processings are not determined legitimate because of low similarity (S404: no), at step S409 the security authentication lock executing module 209 locks authentication processing other than particular authentication processing for lock cancellation. Lock cancellation is necessary when authentication lock has been made. When authentication lock has been cancelled, authentication by the owner of the recording device 208 needs to be performed at step S410. This authentication authority is different from the authority of the ordinary security setting authentication of step S403. At step S411, the host authenticating module 212 determines whether or not the authentication has succeeded. If the authentication has failed, at step S408 the recording device 208 returns an error reply. If the authentication has succeeded, at step S412 the recording device 208 unlocks the authentication lock. Then, the process moves to step S407, where the recording device 208 performs ordinary user data access processing.

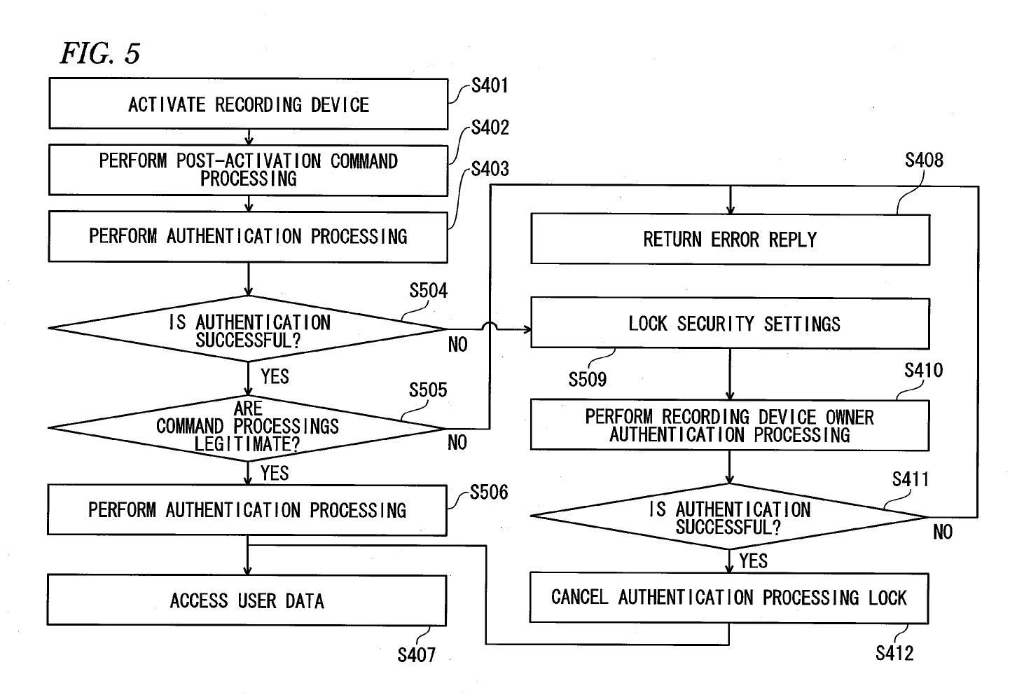

FIG. 5 illustrates another process which uses the above-described firmware and is started by the host 201 (general host) to activate the recording device 208 having the security settings 214. The same steps as shown in FIG. 4 will not be described in detail.

In the recording device 208 which has received the command issued at step S403, at step S504 the host authenticating module 212 checks whether or not authentication has succeeded. If the authentication has failed (S504: no), at step S509 the security setting lock executing module 109 locks the security settings 214.

If the authentication has succeeded (S504: yes), the command tendency determinator 210 determines at step S505 whether or not the command processings of this time are legitimate depending on whether or not similarity between a command tendency of the command processings of this time and the command tendency 216 is sufficiently high.

If the command processings are determined legitimate because of high similarity (S505: yes), at step S506 the recording device 208 performs authentication processing. If the command processings are not determined legitimate because of low similarity (S505: no), at step S408 the recording device 208 returns an error reply.

### [Activation Sequence]

An activation sequence of the recording device 208 which uses SAS (serial attached SCSI) or the like is outlined as follows:

(1) HDD activation

(2) Regular command processing (e.g., “MODE SENSE” and “START UNIT”) performed after the HDD activation

(3) Authentication processing using a security command (in SAS, “SECURITY PROTOCOL IN/OUT”)

(4) Cancellation of the lock of access to user data after success of the authentication

(5) Ordinary use of the recording device 208 (writing or reading)

The host 201 activates the recording device 208 and issues a series of commands to cause the recording device 208 to perform processings that need to be performed after power-on. These commands are irrelevant to security-related processing, and almost equivalent processings (e.g., acquisition of apparatus information and spin-up) need to be performed even in general recording devices not having a security function.

Then, authentication is performed. If the authentication fails, the recording device 208 returns an error reply. If the authentication succeeds, security setting is enabled. The lock of the user data 217 is cancelled by security setting processing and an access right is acquired. If this sequence is finished normally, the host 201 is allowed to user the recording device 208 in an ordinary manner.

For example, an approach to comparative determination of character string similarity may be used for determination of the above-described similarity. In this approach, Levenshtein distances or the like can be used for the purpose of data mining.

The recording device 208 holds a tendency of the post-activation command processing as a command tendency. Plural data of command reception order, reception timing of each command, or the like may be stored and averaged into statistical data. In the recording device 208, the command tendency determinator 210 determines whether the tendency of the command processing of commands issued by the host 201 at the time of the activation are similar to the command tendency 216.

If an abnormality is detected, the security setting lock executing module 209 locks authentication processing other than particular authentication processing for lock cancellation. In practice, the security setting module 213 may be locked instead of authentication processing.

A comparing tendency of command processing performed at the time of activation with a past tendency makes it possible to strengthen the security of ordinary processing with a particular host without performing authentication explicitly.

If an attacker removes only the recording device 208 from the system and takes it out and attacks it in another environment, the security settings 214 are locked (because the command tendency such as timing is changed when the recording device 208 is used with another host) and the presence of a security setting lock 604 as shown in FIG. 6 requires further authentication processing (resetting of the security setting lock 604).

For example, if an abnormality has occurred in the host 201 or the firmware or software of the host 201 has been changed, the tendency of command processing may vary even if the recording device 208 is used by the legitimate user. An auxiliary effect is expected that in that event the end user is alarmed (e.g., notified of a classification of a cause of the abnormality or unrecognized version-up of the firmware or software).

FIG. 6 illustrates the security settings used in the embodiment. The security settings 601 include a user data area setting 602, a password setting 603, and a security setting lock setting 604. The setting (individual descriptions) that substantially exhibits a lock effect is the user data area setting 602, which makes it possible to protect data that was stored by the user or the host 210 from a malicious third person.

To alter the user data area setting 602, it is necessary to verify that a current manipulator is a legitimate person through authentication with the authority described in the password setting 603. In the embodiment, the security at the time of detection of an abnormality is strengthened by security setting lock setting 604. In the example of FIG. 6, the lock setting 604 is “0,” which means that no lock setting is made. The recording device 208 is rendered in a lock-set state if the lock setting 604 is “1,” for example.

### Embodiment 2

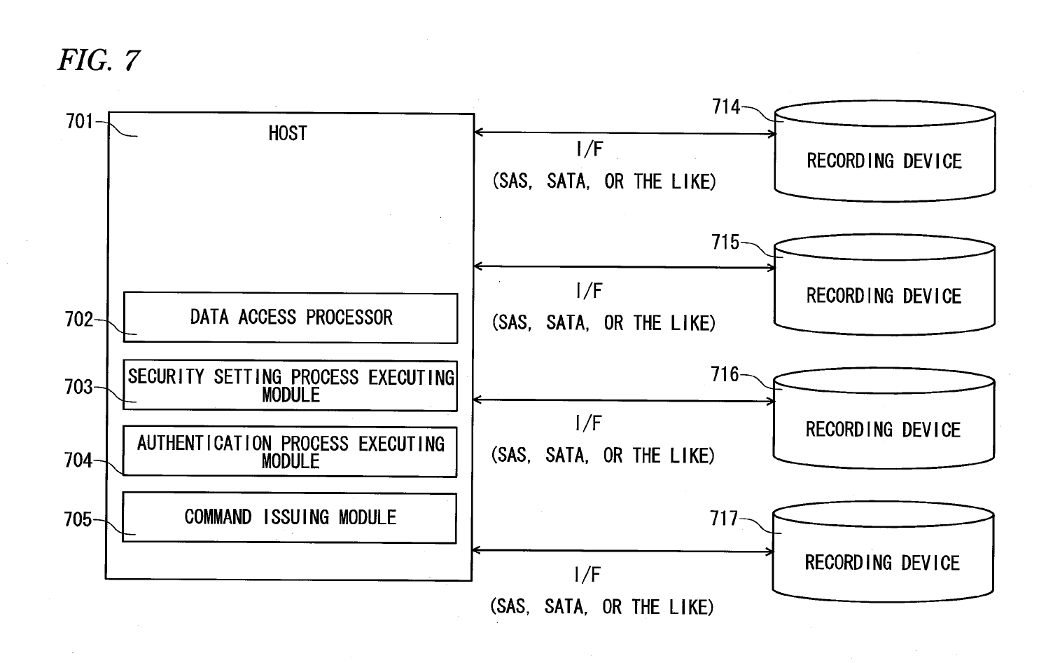

A second embodiment will be described below with reference to FIG. 7. Components, etc. having the same ones in the first embodiment will not be described in detail.

FIG. 7 illustrates a system configuration of an electronic apparatus according to the second embodiment. Recording devices 714-717 are connected to a host 701. The host 701 may be a system such as a server or a PC, an HBA (host bus adapter) having a hard RAID (redundant array of inexpensive/independent disks) function, or the like. Although the internal configuration of each of the recording devices 714-717 are shown in FIG. 7, each of the recording devices 714-717 is equivalent to the recording device 208 shown in FIG. 2. The host 701 is equivalent to the host 201 shown in FIG. 2. More specifically, a data access processor 702, a security setting process executing module 703, an authentication process executing module 704, and a command issuing module 705 are equivalent to the data access processor 202, the security setting process executing module 203, the authentication process executing module 204, and the command issuing module 205, respectively.

Now assume that the host 701 has configured a RAID system using the recording devices 714-716 and the recording device 717 is to be added to the RAID system. In this case, in general, the host 701 performs regular processing, authentication processing, and security setting processing on the recording device 717. Then, the host 701 performs ordinary processing.

The activation process of FIG. 4 according to the first embodiment is applicable to this embodiment except that step S402 (post-activation command processing) is replaced by a step of performing pre-RAID-incorporation regular command processing. The individual steps will not be described because they are almost the same as the corresponding steps of the process according to the first embodiment.

### Modifications to Embodiments

(1) Although the first and second embodiments employ the authentication method which uses a password (example of authentication information), a challenge/response (another example of authentication information) may be used.

In the challenge response authentication, first, a client that wants to have itself authenticated sends an authentication request to a server. In response, the server returns a sequence of random numerical values (called a “challenge”). The client generates a sequence of numerical values called a “response” by combining a user-input password with the challenge according to a particular algorithm and sends it to the server. The server generates a response in the same manner based on the already sent challenge and a password of the user registered in advance, and compares it with the response received from the client. If the two responses coincide with each other, it is found that the received password is correct and the authentication results in success.

Since a response is generated using a unidirectional function or the like, an original password cannot be found even if only the response is acquired. Exchanging a challenge and a response (i.e., an encrypted password incorporated therein) instead of a plain password prevents a password or the like from being tapped.

(2) In the embodiments, to cancel a security setting lock, authentication is performed using the authority of the owner of the recording apparatus. Alternatively, the authority of a vendor of the recording device or a vendor of the host may be used.

(3) Although the embodiments assume that command issuance order or command issuance intervals (timing) are used as a command tendency, their combination may be used for determining similarity between command tendencies.

(4) Although in the embodiments attention is paid to a command sequence at the time of activation, attention may be paid to another kind of characteristic processing such as a recovery from a power saving mode or incorporation into a RAID system.

According to the embodiments, security is made stronger than in the conventional, simple authentication method because of the use of command tendency determination information and security setting lock information. More specifically, when an attacker removes the recording device from the system and attacks it, the attacker is forced to break more authentication barriers than in ordinary use of the user and hence the success rate of the attack would be lowered. The same advantage is obtained by the above-described modifications (1)-(5). The above-described embodiments have the following three important features:

(1) The recording device 208 has the host authenticating module 212, the security settings 214, and the security setting module 213 for making security settings.

(2) The recording device 208 has the past command (sequence) tendency 216 and the command tendency determinator 210.

(3) If the command tendency determinator 210 determines that an abnormality has been detected, the security setting module 213 is disabled (i.e., the security setting lock executing module 209 is provided).

The embodiments provide an advantage that the information security and the ability to check the details of work can be increased in business information systems.

The invention is not limited to the above embodiments, and can be practiced so as to be modified in various manners without departing from the spirit and scope of the invention.

And various inventive concepts may be conceived by properly combining plural constituent elements disclosed in each embodiment. For example, several ones of the constituent elements of each embodiment may be omitted. Furthermore, constituent elements of different embodiments may be combined as appropriate.

1. A recording device, comprising:
a data storage module configured to store data;
an authentication information storage module configured to store authentication information to be used for an authentication of access to the data storage module;
a receiving module configured to receive authentication information that is transmitted from a higher level apparatus;
an authenticating module configured to perform the authentication of access to the data storage module by comparing the authentication information received by the receiving module with the authentication information stored in the authentication information storage module;
a command tendency storage module configured to store a command tendency, the command tendency comprising an order or a timing of commands that have been transmitted from the higher level apparatus;
a command tendency determinator configured to determine whether or not a command tendency relating to commands being transmitted from the higher level apparatus is similar to the command tendency previously having been stored in the command tendency storage module; and
a use disabling module configured to render the data stored in the data storage module substantially unusable based on a determination of the command tendency determinator.

2. The device of claim 1,
wherein the use disabling module is configured to render the data stored in the data storage module substantially unusable by disabling the authenticating module or part of predetermined processing that is necessary for use of the data stored in the data storage module.

3. The device of claim 2,
wherein the use disabling module is configured to disable the part of the predetermined processing that is necessary for use of the data stored in the data storage module by not executing a predetermined command that is transmitted from the higher level apparatus and is necessary for use of the data stored in the data storage module.

4. The device of claim 1, further comprising:
a security setting module connected to the higher level apparatus,
wherein the use disabling module is configured to render the data stored in the data storage module substantially unusable by disabling the security setting module.

5. A control method of a recording device comprising an access authenticating module, the access authenticating module comprising a data storage module, an authentication information receiving module and an authentication information storage module, the method comprising:
managing access to data;
receiving authentication information;
determining whether or not the access to data is legitimate based on command tendency information relating to commands received before receiving the authentication information; and
prohibiting the managing of access to data if the access to data is determined not to be legitimate.

6. The method of claim 5,
wherein prohibiting the managing of access to data comprises disabling the authenticating module or part of predetermined processing that is necessary for use of the data stored in the data storage module.

7. The method of claim 6,
wherein prohibiting the managing of access to data comprises disabling the part of the predetermined processing that is necessary for use of the data stored in the data storage module by not executing a predetermined command that is transmitted from a higher level apparatus and that is necessary for use of the data stored in the data storage module.

8. The method of claim 5,
wherein the recording device further comprises a security setting module connected to a higher level apparatus, and
wherein prohibiting the managing of access to data comprises disabling the security setting module.
